(19) United States
(12) Patent Application Publication
(10) Pub. No.: US 2016/0101441 A1
(43) Pub. Date: Apr. 14, 2016

(54) WASHER

(71) Applicants: FU DING ELECTRONICAL TECHNOLOGY (JIASHAN) CO., LTD., Zhejiang (CN); HON HAI PRECISION INDUSTRY CO., LTD., New Taipei (TW)

(72) Inventor: HUI-CHAO DING, Jiashan (CN)

(21) Appl. No.: 14/686,336

(22) Filed: Apr. 14, 2015

(30) Foreign Application Priority Data
Oct. 8, 2014 (CN) 201420576586.1

(51) Int. Cl. B08B 3/02; B08B 3/14

(52) U.S. Cl. CPC B08B 3/022; B08B 3/14

(57) ABSTRACT

A washer configured to wash a product includes a support frame, a transmission mechanism mounted to the support frame, a guide mechanism mounted to a top of the transmission mechanism, and a washing mechanism mounted adjacent to the transmission mechanism. The transmission mechanism includes a plurality of rollers mounted to the ends of the support frame and a plurality of transmission belts mounted to the rollers. The washing mechanism includes a plurality of washing elements. The plurality of washing elements are arranged at the top and bottom edges of the plurality of transmission belts. A plurality of outlet holes are defined in positions of washing elements adjacent to the plurality of transmission belts. Cleaning fluid sprayed from the plurality of outlet holes forms an intersecting liquid curtain to wash the product.

### FIELD

The subject matter herein generally relates to washers, especially to a horizontal washer configured to wash the surface of products.

### BACKGROUND

Contaminants, such as metal filings, generally form and cling to the surface of metal products during manufacturing, resulting in the quality of product inspection and process being affected.

### BRIEF DESCRIPTION OF THE DRAWINGS

Implementations of the present technology will now be described, by way of example only, with reference to the attached figures.

FIG. 1 is an isometric view of an embodiment of a washer.

FIG. 2 is a top view of the washer of FIG. 1.

FIG. 3 is a enlarged view of the washer of FIG. 2.

FIG. 4 is a cross-sectional view of the washer of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

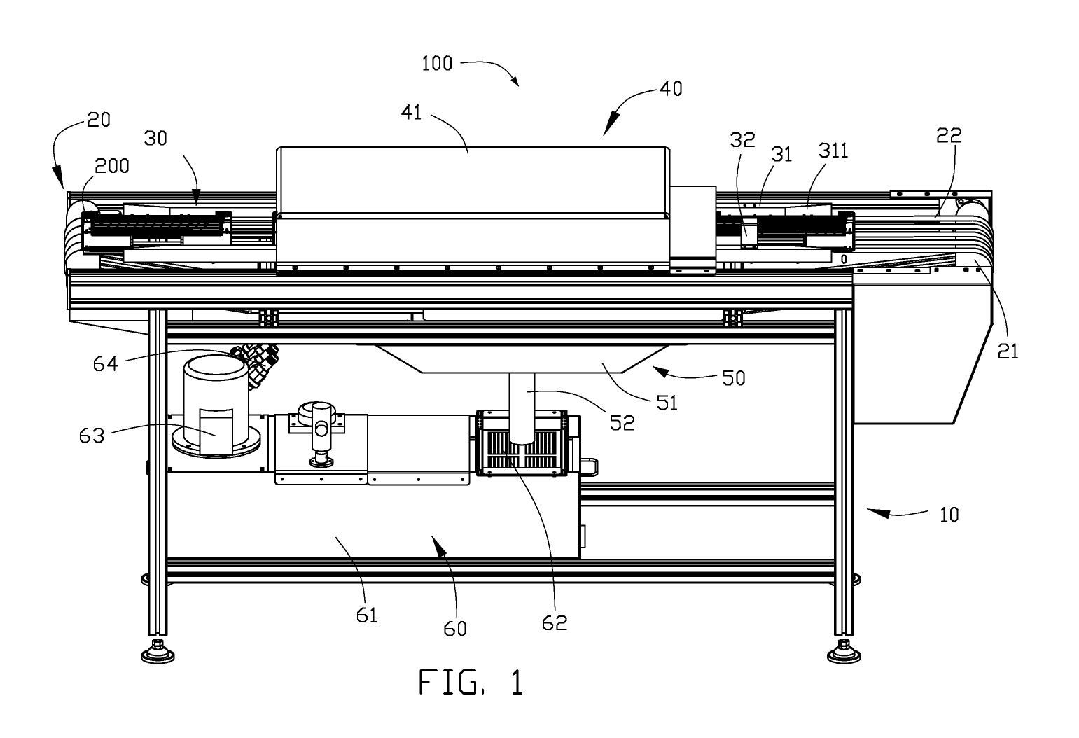

FIG. 1 illustrates an embodiment of a washer 100. The washer 100 can be configured to wash a surface of a product 200. The washer 100 can include a support frame 10, a transmission mechanism 20 mounted to the support frame 10, a guide mechanism 30 mounted to a top of the transmission mechanism 20, a washing mechanism 40 mounted adjacent to the transmission mechanism 20, a collection mechanism 50 mounted to a bottom of the transmission mechanism 20 and a recycle mechanism 60 mounted to a bottom of the collection mechanism 50. The product 200 can be placed on the transmission mechanism 20 and be guided into the washing mechanism 40 by the guide mechanism 30. The washing mechanism 40 can be configured to wash and dry the product 200. The collection mechanism 50 can be configured to collect the used cleaning fluid, and the collected cleaning fluid can flow into the recycle mechanism 60. The recycle mechanism 60 can filter the used cleaning fluid and transmit the filtered cleaning fluid to the washing mechanism 40. The cleaning fluid can be recycled in the washer 100.

The transmission mechanism 20 can include a plurality of rollers 21 mounted to the ends of the support frame 10 and a plurality of transmission belts 22 concurrently coupled to the plurality of rollers 21. The rollers 21 can rotate to move the transmission belts 22.

The guide mechanism 30 can include a plurality of rails 31 arranged in parallel and a sensor 32 mounted to one of the rails 31. Guide bevels 311 can be arranged at the ends of each rail 31. The product 200 can enter between the rails 31 guided by the guide bevels 311. The sensor 32 can be configured to sense the product 200 entering between the rails 31. The sensor 32 can generate a control signal when the product 200 enters between the rails 31. The washing mechanism 40 can wash the product 200 by receiving the control signal from the sensor 32.

The washing mechanism 40 can include a cover 41. The cover 41 can allow the washing mechanism 40 to wash the product 200 in a closed environment and prevent the cleaning fluid from splashing.

The collection mechanism 50 can include a collection tank 51 and a draft tube 52 mounted to a bottom of the collection tank 51. The collection tank 51 can be substantially funnel-shaped and mounted under the plurality of transmission belts 22 to collect the cleaning fluid. The draft tube 52 can allow the cleaning fluid collected by the collection tank 51 to flow into the recycle mechanism 60.

The recycle mechanism 60 can include a box 61, a strainer 62, a collection pump 63 and an outlet pipe 64. The cleaning fluid collected by the collection mechanism 50 can enter the box 61 through the strainer 62. The box 61 can be configured to contain the cleaning fluid. The strainer 62 can be configured to filter impurities from the cleaning fluid. The collection pump 63 can transmit the cleaning fluid in the box 61 to the washing mechanism 40 through the outlet pipe 64.

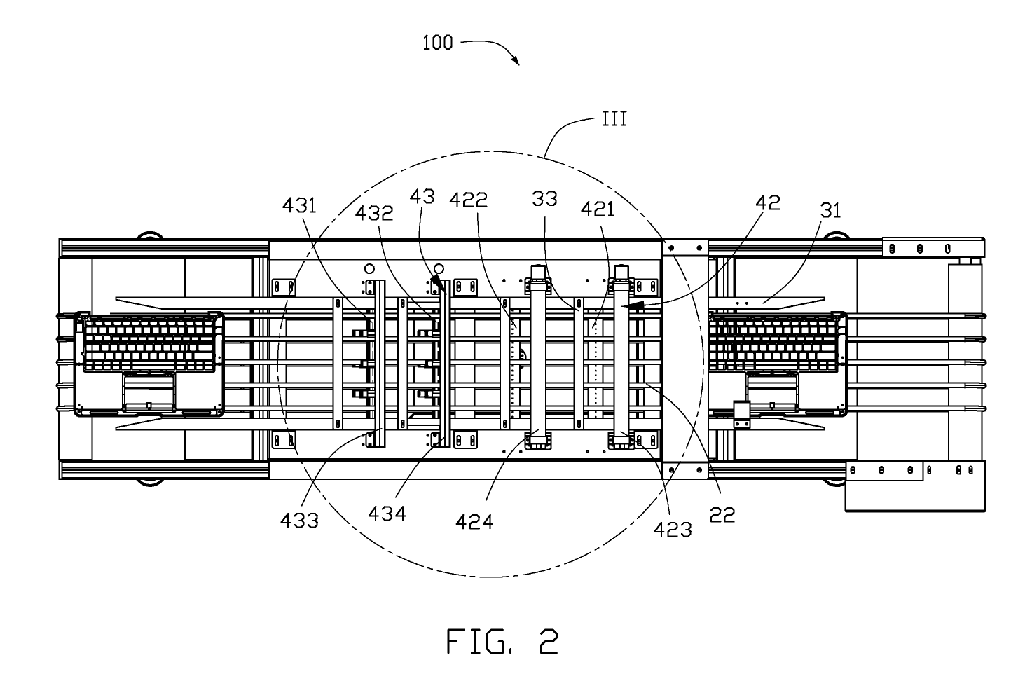

FIG. 2 illustrates a plurality of limiting displacement bars 33 can be mounted to the top of the plurality of rails 31. The limiting displacement bars 33 can be made of soft materials. The limiting displacement bars 33 can be configured to limit the product 200 on the plurality of transmission belts 22 and can prevent damage to the product 200 when being washed by the wash mechanism 40.

The washing mechanism 40 can further include a washing member 42 and a drying member 43.

The washing member 42 can include a first washing element 421, a second washing element 422, a third washing element 423 and a fourth washing element 424. The first washing element 421 and the third washing element 423 can be arranged at the top and bottom edges of the plurality of transmission belts 22. The second washing element 422 and the fourth washing element 424 can be arranged at the top and bottom edges of the plurality of transmission belts 22.

The drying member 43 can include a first drying element 431, a second drying element 432, a third drying element 433 and a fourth drying element 434. The first drying element 431 and the third drying element 433 can be arranged at the top and bottom edges of the plurality of transmission belts 22. The second drying element 432 and the fourth drying element 434 can be arranged at the top and bottom edges of the plurality of transmission belts 22.

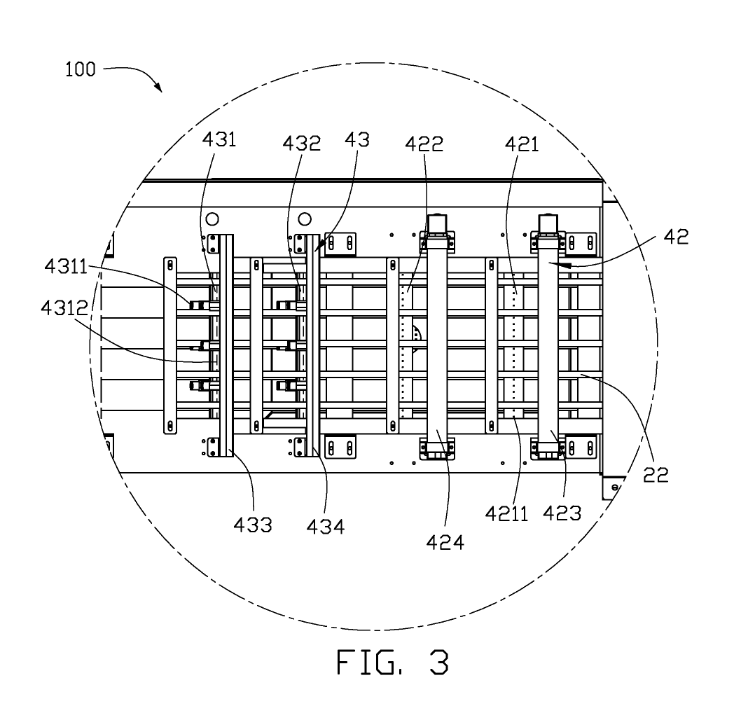

FIG. 3 illustrates the first washing element 421 can be a hollow tube. One end of the first washing element 421 can be closed, and the other end of the first washing element 421 can be coupled to the outlet pipe 64. A plurality of outlet holes 4211 can be defined in the position of the first washing element 421 adjacent to the plurality of transmission belts 22. The cleaning fluid can be sprayed at the surface of the product 200 through the plurality of outlet holes 4211 to wash the product 200. Structures of the second washing element 422, the third washing element 423 and the fourth washing element 424 can be the same as that of the first washing element 421.

The cleaning fluid can be respectively sprayed from the first washing element 421, the second washing element 422, the third washing element 423 and the fourth washing element 424 and can form an intersecting liquid curtain, and can cover a plane when moved on the same plane. Therefore, the cleaning fluid can fully wash the product 200 and remove the contaminants from the surface of the product 200.

The first drying element 431 can be a hollow tube. Ends of the first drying element 431 can be closed. An inlet opening 4311 can be defined in the first drying element 431. The inlet opening 4311 can be coupled to an air pump (not shown), and air can enter the first drying element 431 through the inlet opening 4311. A plurality of air clefts 4312 can be defined in the position of the first drying element 431 adjacent to the plurality of transmission belts 22. Air passing through the air clefts 4312 can blow the cleaning fluid from the surface of the product 200. Structures of the second drying element 432, the third drying element 433 and the fourth drying element 434 can be same as that of the first drying element 431.

In another embodiment, the washing mechanism 40 can include two washing elements or more to ensure the top and bottom edges of the plurality of transmission belts 22 can be arranged by the washing elements. The washing mechanism 40 can include two drying elements or more to ensure the top and bottom edges of the plurality of transmission belts 22 can be arranged by the drying elements.

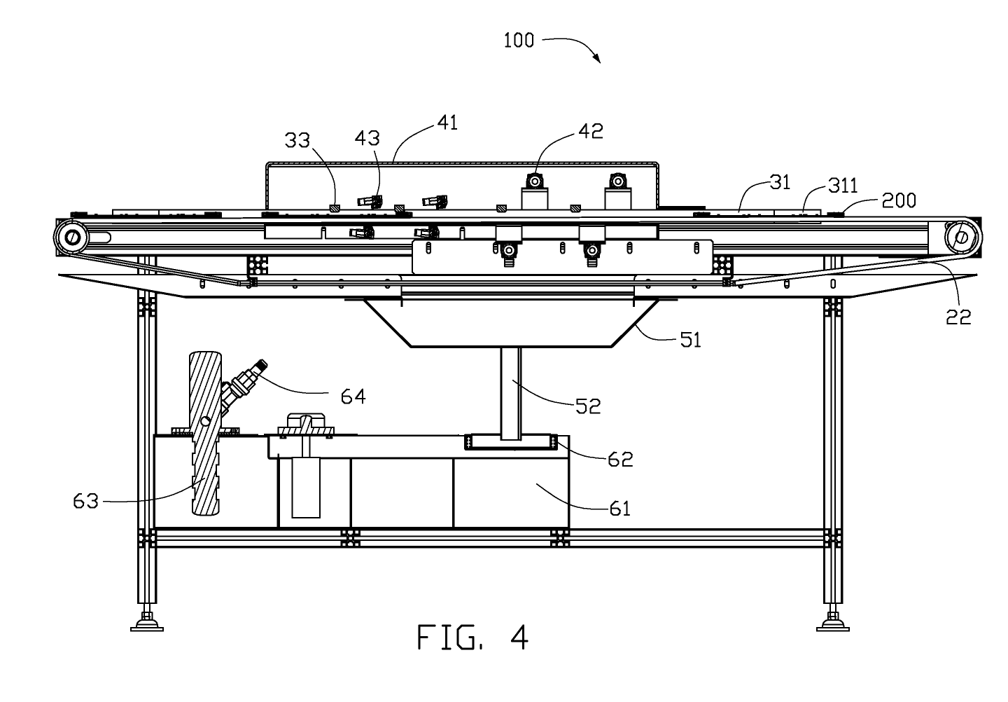

FIG. 4 illustrates operation principles of the washer 100. The product 200 can be placed on the plurality of transmission belts 22 which move the product 200 toward the cover 41. In the movement, the product 200 can enter between the rails 31 guided by the guide bevels 311. The sensor 32 can generate a control signal when sensing the product 200 entering between the rails 31. The washing mechanism 40 can start by receiving the control signal from the sensor 32. The washing members 42 can fully wash the product 200 and remove the contaminants from the surface of the product 200, and the drying members 43 can dry the cleaning fluid on the surface of the product 200. The limiting displacement bars 33 arranged at the top edge of the plurality of transmission belts 22 can prevent the product 200 from touching the drying members 43 and can prevent the product 200 from being damaged by the drying members 43 arranged at the top edge of the plurality of transmission belts 22.

The used cleaning fluid can be collected by the collection tank 51 and can flow into the box 61 through the draft tube 52. The strainer 62 can filter impurities in the cleaning fluid. The collection pump 63 can transmit the cleaning fluid filtered by the strainer 62 to the washing mechanism 40 through the outlet pipe 64. Therefore, the cleaning fluid can be recycled in the washer 100.

The embodiments shown and described above are only examples. Many details are often found in the art such as the other features of a washer. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A washer configured to wash a product comprising:
a support frame;
a transmission mechanism comprising a plurality of rollers mounted to the support frame and a plurality of transmission belts concurrently coupled to the plurality of rollers;
a guide mechanism configured to guide the product; and
a washing mechanism comprising a plurality of washing elements respectively arranged at top and bottom edges of the plurality of transmission belts;
wherein the plurality of washing elements define a plurality of outlet holes, the plurality of outlet holes spray cleaning fluid, and the cleaning fluid forms an intersecting liquid curtain to wash the product.

2. The washer as claimed in claim 1, wherein the washer further comprises a recycle mechanism, and the recycle mechanism comprises a box, a strainer, a collection pump and an outlet pipe.

3. The washer as claimed in claim 2, wherein the box is configured to contain the cleaning fluid, the strainer is configured to filter impurities in the cleaning fluid before the cleaning fluid enters the box, and the collection pump transmits the cleaning fluid in the box to the washing mechanism through the outlet pipe.

4. The washer as claimed in claim 2, wherein the washer further comprises a collection mechanism configured to collect the cleaning fluid.

5. The washer as claimed in claim 4, wherein the collection mechanism comprises a collection tank and a draft tube, the collection tank is mounted under the plurality of transmission belts, and the draft tube leads the cleaning fluid collected by the collection tank into the recycle mechanism.

6. The washer as claimed in claim 1, wherein the washing mechanism further comprises a plurality of drying elements arranged at the top and bottom edges of the plurality of transmission belts.

7. The washer as claimed in claim 6, wherein each drying element comprises an inlet opening and defines a plurality of air clefts in a position adjacent to the plurality of transmission belts.

8. The washer as claimed in claim 1, wherein the guide mechanism comprises a plurality of rails arranged in parallel and a sensor mounted to one of the rails, the sensor is configured to sense the product entering between the rails and generate a control signal configured to control the washing mechanism.

9. The washer as claimed in claim 8, wherein the guide mechanism further comprises a plurality of limiting displacement bars, and the limiting displacement bars are mounted to the top of the plurality of rails and limit the product on the plurality of transmission belts.

10. The washer as claimed in claim 8, wherein ends of each rail define guide bevels, and the guide bevels is configured to guide the product entering between the rails.

11. The washer as claimed in claim 1, wherein the washing mechanism comprises a cover, and the cover allows the washing mechanism wash the product in a closed environment and prevent the cleaning fluid from splashing.

12. The washer as claimed in claim 2, wherein each washing element is a hollow tube, and one end of the washing element is closed, and another end of the washing element is coupled to the outlet pipe.

13. The washer as claimed in claim 1, wherein each drying element is a hollow tube, and ends of each drying element are closed.
